(19) United States
(12) Patent Application Publication
(10) Pub. No.: US 2008/0237545 A1
(43) Pub. Date: Oct. 2, 2008

(54) Advanced Anisotropic Insulated Conductive Ball For Electric Connection, Preparing Method Thereof and Product Using the Same

(75) Inventors: Eui-Deok Kim, Daejeon-city (KR); Joo-Seok Oh, Daejeon-city (KR); Ki-Suk Park, Seoul-city (KR); Seoung-Whan Shin, Daejeon-city (KR)

Correspondence Address: THE WEBB LAW FIRM, P.C., 700 KOPPERS BUILDING, 436 SEVENTH AVENUE, PITTSBURGH, PA, 15219, US

(73) Assignee: HANWHA CHEMICAL CORPORATION, Seoul (KR)

(21) Appl. No.: 11/815,304

(22) PCT Filed: Feb. 2, 2006
(86) PCT No.: PCT/KR06/00368

§ 371 Date: Apr. 16, 2008

(30) Foreign Application Priority Data
Feb. 2, 2005 (KR) 10-2005-0009657

(51) Int. Cl. H01B 1/12; B05D 5/12

(52) U.S. Cl. 252/500; 427/58

(57) ABSTRACT

Disclosed are anisotropic conductive balls for electric connection comprised of conductive balls and insulation resin layers coating the surfaces of those conductive balls. The conductive balls are coated with a core-shell-structured emulsion-phase or suspension-phase or water-dispersible resin to form insulation resin layers as the shells of the insulation resin layers are coated with resin layers having the water-emission ability. Also disclosed are methods of manufacturing anisotropic conductive balls for electric connection as well as the products using them. Although the surfaces of the anisotropic conductive balls are coated with single- or multi-layered insulation resin layers, they show superior alive and insulation characteristics.

### TECHNICAL FIELD

The present invention is related to anisotropic insulated conductive balls for electric connection, methods of manufacturing them, and products using them. More concretely, the present invention is related to anisotropic insulated conductive balls for electric connection showing superior alive characteristics and insulation characteristics with the defects of the conventional anisotropic conductive balls for electric connection coated with a thermoplastic resin or a thermosetting resin improved as their surfaces are coated with an insulation resin and a resin having the water-emission ability. The present invention is also related to the methods of manufacturing the above as well as the products using the above.

### BACKGROUND ART

As electronic parts such as semi-conductors, substrates, etc. have been miniaturized and thinner, circuits and connection terminals have become denser and more elaborate. For the connection of such minute circuits, the anisotropic electric connection method has been used frequently. In the anisotropic electric connection, the film- or paste-shaped anisotropic electric connection material, in which minute conductive particles are dispersed in an insulating adhesive, is inserted into the gap between connection terminals, and then, heated and pressurized to make them alive and adhered.

Recently, as the patterns of connection terminals that have been the objects of anisotropic electric connection have become more detailed, there have been concerns for the generation of short among adjacent terminals during the anisotropic electric connection. Accordingly, so-called insulated conductive balls, of which surfaces have been coated with thin thermoplastic resin layers or thermosetting resin layers, have been used as conductive balls for anisotropic electric connection.

However, insulated conductive balls that have been developed and used up to the present time have had many problems. For instance, if a thermoplastic resin was used for the material for insulated clothes, they were damaged by the solvent during the process of manufacturing the anisotropic conductive material thus failing to demonstrate the capacity of insulation which was the object of its use. Whereas, if coating layers were formed with a thermosetting resin, there were the same problems as those of the thermoplastic resin with a too low cross-linking density since it was not easy to control the cross-linking density, and if the cross-linking density was too high, electrodes were not made alive since the coated layers were not peeled off during the process of anisotropic connection.

Further, as to the process of coating, there have been the conventional methods of coating insulating materials including the solution impregnation method, interface polymerization method, in situ polymerization method, spray-drying method, vacuum evaporation method, physical or mechanical hybridization method, etc. And yet, it has been difficult to obtain insulation coated layers having an even and sufficient thickness.

Moreover, in case of conductive balls coated with a thermoplastic resin, there were problems that the thermoplastic resin film was peeled off by the solvent used for the manufacture of the anisotropic material for electric connection, solvents that might be used were limited, and the composition of mixing was limited. And negative effects on the environment and human bodies by the use of solvents were not insignificant.

Still further, the problem of short among adjacent terminals occurring as a result of softening and easy flowing of film layers by heating and pressurizing during the process of anisotropic electric connection was not insignificant either. Moreover, recently, anisotropic materials for electric connection containing a large number of small-sized balls have been used for the reliable connection of minute circuits, where the ratio of the thermoplastic resin has been increased as the ratio of mixing of conductive balls in the anisotropic materials for electric connection has been increased. As a result, there have occurred problems that thermal resistance of the anisotropic materials for electric connection has been lowered, and insulation characteristic (the characteristic that the insulation state among patterns could have been maintained if only the insulation state among conductive balls has been maintained) has not been maintained properly since it has been easy for conductive balls to be coagulated by softening of the thermoplastic resin on the surfaces of conductive balls if the interval among terminals for connection has become narrow.

In the meantime, in case of conductive balls coated with a thermosetting resin, there have been problems that electrode terminals, that have been the objects of connection, have been damaged since it has been necessary to pressurize conductive balls at a high pressure in order to destroy the insulation films of conductive balls during anisotropic electric connection although there have been no problems with the use of conductive balls coated with a thermoplastic resin. Further, it has been disadvantageous that making alive of electrodes has not been done reliably since thin pieces of films have not been removed completely.

Nevertheless, recently, it has been reported by Sony Chemical Company that they have manufactured insulated conductive corpuscles by adhering cross-linked polymer corpuscles having a proper cross-linkage to conductive corpuscles in the vapor phase in order to solve the above-described problems. However, it has been difficult to obtain a desirable adhesion force between the metal layer and the insulation resin layer since homogeneous coating has not been possible and polymer coating layers have not been cross-linked in view of the process of manufacturing. Also, there has been the problem of refining after coating since it has been inevitable to have coagulated balls generated in view of the process of manufacturing.

Still further, in case of adhesives used for the manufacture of anisotropic materials for electric connection, there have been problems of long-term reliability such as an increased alive resistance but a lowered insulation resistance under the conditions of high temperature and high humidity since a considerable amount of moisture absorption has been known.

### DISCLOSURE OF INVENTION

### Technical Problem

Accordingly, in the present invention, it was found that polymer resins that were melted in water and in the emulsion or suspension state, or water-dispersible polymer resins, having a core-shell structure showed superior insulation characteristics and were able to solve the above-described problems as insulation resins for coating conduction balls, were able to improve insulation property through coating with a resin having the water-emission ability again onto the shells of insulated conductive balls as described in the above, and were able to solve the problem of reliability brought about when they were exposed to the conditions of high temperature and high humidity.

Therefore, it is an object of the present invention to provide anisotropic insulated conductive balls for electric connection with improved alive and insulation characteristics that are difficult to obtain for the conventional anisotropic conductive balls for electric connection coated with a thermoplastic resin or a thermosetting resin in spite of that their surfaces are coated with an insulation resin and a resin having the water-emission ability.

It is another object of the present invention to provide methods of manufacture of the above anisotropic insulated conductive balls for electric connection.

It is still another object of the present invention to provide anisotropic materials for electric connection manufactured by using the above anisotropic insulated conductive balls for electric connection.

It is yet another object of the present invention to provide connection structural bodies obtained by using the above anisotropic materials for electric connection.

Anisotropic conductive balls for electric connection according to the present invention to achieve the above-described objects are comprised of conductive balls, insulation resin layers formed on the surfaces of conductive balls as a core-shell-structured emulsion or suspension or water-dispersible resin is coated, and single-layered or multi-layered insulation resin layers formed through coating their shells with resin layers having the water-emission ability simultaneously.

The method of manufacture of the anisotropic insulated conductive balls for electric connection according to the present invention to achieve another object of the present invention is comprised of the steps of melting an emulsion or suspension having a core-shell structure, or a resin dispersible in water, in water; fixing it to the surfaces of conductive balls in an aqueous solution to form insulation resin layers; and coating their shells with resin layers having the water-emission ability to form single- or multi-layered insulation resin layers.

Anisotropic materials for electric connection to achieve still another object of the present invention are formed as the above anisotropic conductive balls for electric connection are dispersed in insulating adhesives.

Connection structural bodies to achieve yet another object of the present invention are formed as two objects to be connected facing each other are connected by using the above anisotropic material for electric connection.

### Technical Solution

The present invention is illustrated in more detail as follows:

As described in the above, the present invention is related to anisotropic conductive balls for electric connection comprised of conductive balls and insulation resin layers coating the surfaces of the conductive balls. That is, provided in the present invention are multi-layered anisotropic conductive balls for electric connection coated with insulation resin layers and a resin having the water-emission ability again.

The insulation resin layers according to the present invention are manufactured by adding conductive balls to the aqueous emulsion or suspension of multi-layered corpuscles, mixing them, coating the surfaces of conductive balls with the resin corpuscles, and heating them at a proper temperature. Resin layers having the water-emission ability may be manufactured in the same method.

The above-described insulation materials adhere to metal layers strongly enabling to form homogeneous insulation layers readily, and once formed, insulation layers have superior thermal resistance and mechanical strength making it difficult to be detached by physical impact. They also have an extremely superior solvent resistance, and therefore, are not dissolved or deformed but stable during the process of manufacturing anisotropic materials for electric connection. Still further, resin layers having the water-emission ability are designed to have a superior adhesive force to insulation layers, and can solve the problem of long-term reliability related to high temperature and high humidity that is the matter of concern in the manufacture of anisotropic materials for electric connection. Nevertheless, in the process of conductive connection using anisotropic materials for electric connection containing insulated conductive corpuscles according to the present invention, insulation resin and resin layers having the water-emission ability flow easily when they are heated or compressed, and the surface of the metal is exposed promptly, thus enabling the stable alive connection among electrode terminals to be connected.

A single anisotropic conductive ball for electric connection according to the present invention is largely divided into a conductive ball (1), an insulation resin layer (2), and a resin layer having the water-emission ability (3) as shown in FIG. 1 briefly.

It is preferable that the total thickness (average thickness) of the insulation resin layer (2) and resin layer having the water-emission ability (3) in the anisotropic conductive ball for electric connection of the present invention is less than ⅕ of the diameter of the conductive ball but greater than 10 [symbol] since alive characteristics are lowered if the ratio with respect to the diameter of the conductive ball (1) becomes too large, and insulation characteristics are not sufficient if the ratio is too small. The diameter of a general conductive ball (1) is 2˜10 [symbol] .

Major physical properties required by insulation resin layers are proper mechanical strength, solvent resistance, and thermal resistance. Insulation resin layers should be maintained stably during the processes of mechanical stirring and mixing when manufacturing anisotropic materials for electric connection. And they should be resistant to ketones such as acetone, MEK, MIBK, etc.; hydrocarbon solvents such as toluene, benzene, xylene, etc.; and common industrial solvents including THF, DMF, DMSO, etc.

Also, insulation resin layers should not flow unless they are pressurized even if they are heated. Otherwise, phase separation as well as coagulation of conductive balls may occur due to the flow of the insulation resin layers, and short among adjacent terminals may occur as metal layers are exposed during the process of anisotropic electric connection. Nevertheless, it is not desirable if the softening temperature or glass transition temperature of insulation resin layers is higher than the temperature of the process of anisotropic electric connection. It is because the detachment of the insulation resin layers can not be secured unless the resin is softened during the process of connection. The temperature of heating during anisotropic electric connection varies according to the type of an adhesive to be used, etc., but, generally, it is in the range of 120˜210° C.

In the present invention, it was found that it was preferable to use core-shell-structured corpuscles, or emulsion or suspension resin corpuscles for insulation resins meeting the above requirements. An example of a core-shell resin is a styrene methacrylate co-polymer resin. As shown in FIG. 2, the main component of the core (4) of the above resin is styrene methacrylate co-polymer, and this core is surrounded by a shell (5) made form the styrene—methacrylic acid co-polymer.

The core (4) of a core-shell resin grants mechanical strength and thermal resistance to insulation layers, and the shell (5) grants the adhesion force with a metal. Also, the shell (5) forms a pseudo-cross-linked or cross-linked structure through a cross-linking reaction accompanied by hydrogen bonding and dehydration among the shells of adjacent corpuscles after it is coated on the surfaces of conductive balls, and adds strength and solvent resistance to the insulation resin layers. As a result, the resin coated with acryl styrene core-shell co-polymer corpuscles has a high mechanical strength and a superior solvent resistance simultaneously, and form insulation layers having even thickness and morphology.

According to the present invention, it is preferable that the above core is formed with the co-polymer of styrene and alkyl methacrylate having a molecular weight of 100,000˜1,000,000 in view of the mechanical strength and stability after coating, and that the above shell is a resin comprised of styrene and methacrylic acid. Further, it is preferable that the weight ratio between the above core and shell is 30˜95:5˜70 in view of the performance of coating and mechanical strength. Still further, it is preferable that the weight ratio between styrene and alkyl methacrylate comprising the above core is 1:0.3˜2 in view of the strength of adhesion to the shell layer.

It is preferable that the diameter of the insulation resin having the above core-shell structure is 20˜200 nm in view of insulation and alive characteristics, and the glass transition temperature of the above insulation resin is −30˜180° C. in view of processing of ACF and thermal resistance.

It is also found in the present invention that, preferably, the resin having the water-emission ability meeting the above requirements is an emulsion or suspension, in which resin powder having the water-emission ability is dispersed in water. Examples of emulsion resins include co-polymer resins of perfluorinated alkyl acrylate and alkyl acrylate having an average weight molecular weight of 50,000 500,000 or co-polymer resins of silicon and acrylic acid having an average molecular weight of 20,000 3,000,000. These co-polymer resins facilitate increasing of the adhesive force with the above insulation layer resin as well as implementation of the water-emission ability.

In the meantime, it is very difficult to coat a general resin on the surfaces of corpuscles to have a thickness of tens to hundreds nm. Presented in Japanese Patent Application No. H8-13076 are many methods including the interface polymerization method, in situ polymerization method, spray-drying method, vacuum evaporation method, etc. as the methods for coating corpuscles with resin layers; and presented in Japanese Patent Application No. S62-71255 is the solution impregnation method. However, all these are problematic in that it is difficult to coat even insulation resin layers having the thickness of greater than tens˜hundreds nm. That is, the methods disclosed in Japanese Patent Application No. H8-13076 bring about the coagulation of corpuscles, and the method described in Japanese Patent Application No. S62-71255 makes it difficult to form insulation layers having the thickness of hundreds nm. Also introduced in Korean Patent Application No. 2001-060234 is a method of attaching the corpuscles of a cross-linked polymer manufactured in advance to the surfaces of conductive balls physically in the vapor phase. However, as pointed out in the above, this method is also problematic in that homogeneous coating can not be made and bonding among corpuscles is weak, making the mechanical strength and solvent resistance of coated layers weakened as a result.

On the contrary, the present invention is advantageous in that it is possible to control the diameter of corpuscles having the core-shell structure or of emulsified or suspended corpuscles to be tens˜hundreds nm as desired, and to coat their shells with resin layers having the water-emission ability additionally, thus making it easy to control the thickness of the insulation resin layers coated on the surfaces of conductive balls.

In the present invention, conductive balls that are the same as the conventional anisotropic conductive balls for electric connection may be used for the conductive balls coated with the insulation resin. For example, metal balls such as solder balls, nickel balls, etc. and complex conductive balls in which the surfaces of resin corpuscles are plated with a metal, etc. may be used.

Anisotropic conductive balls for electric connection according to the present invention may be manufactured by forming insulation resin layers and water-emission layers on the surfaces of conductive balls (1) by putting conductive balls into the aqueous solution of the above-described insulation resin and water-emission resin, stirring slowly at a proper temperature for a proper time, and letting them stood still. The cross-linked insulation resin layers may be also manufactured by using a cross-linking agent for the insulation resin layers formed.

It is possible to manufacture paste-shaped or film-shaped anisotropic materials for electric connection by dispersing the anisotropic conductive balls for electric connection of the present invention in an insulating adhesive. Adhesives that are the same as those for publicly known anisotropic materials for electric connection may be used as insulating adhesives.

It is also possible to obtain connection structural bodies showing superior alive and insulation characteristics as well as connection strength by inserting an anisotropic material for electric connection between two objects to be connected facing each other (a semi-conductor element and the substrate for mounting it, a pliable wiring substrate and a liquid crystal display, etc.) using anisotropic conductive balls for electric connection of the present invention, and heating and pressurizing the anisotropic material.

### BRIEF DESCRIPTION OF THE DRAWINGS

A more complete appreciation of this invention, and many of the attendant advantages thereof, will be apparent as the same becomes better understood by reference to the following detailed description when considered in conjunction with the accompanying drawings, wherein:

FIG. 1 is the cross-sectional diagram of a single anisotropic conductive ball for electric connection according to the present invention; and

FIG. 2 is the schematic cross-sectional diagram of the structure of a corpuscle comprising the insulation resin layer applied to the anisotropic conductive balls for electric connection according to the present invention.

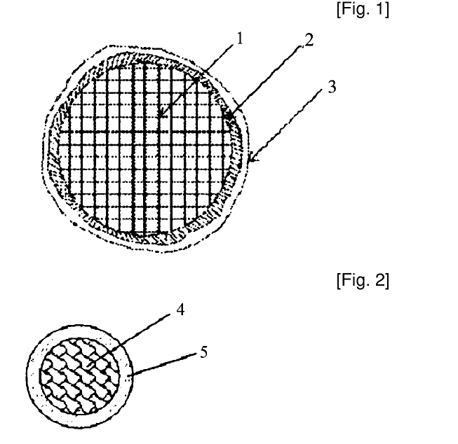

1. Conductive ball
2. Insulation resin layer
3. resin layer having the water-emission ability
4. Core
5. Shell

### MODE FOR THE INVENTION

The present invention is illustrated in more detail in terms of preferred embodiments as follows:

### MANUFACTURING EXAMPLE 1

### Manufacture of Insulation Resin Powder (Core-Shell-Structured Resin) According to the Present Invention

Manufacture of a Shell (SAA Resin)

The mixture of styrene (10.0 g), acrylic acid (10.0 g), and a-methyl styrene (10.0 g), and the mixture of tert-butyl peroxybenzoate (1.2 g), dipropylene glycol methyl ether (3.0 g), 2-hydroxyethyl acrylate (HEA) (10.0 g), and 2-hydroxyethyl methacrylate (10.0 g) were put into a 100-ml high-pressure reactor having a stirrer attached, and heated until the temperature of the reaction mixture reached 200° C. The reaction mixture was stirred for 20 minutes at this temperature, cooled to a room temperature, and dried in a vacuum oven to manufacture the shell (of SAA resin).

Manufacture of a Core-Shell Resin

15 g of the above SAA resin was melted in 80 g of the mixture of water and liquid ammonia. If necessary, the mixture was heated to about 90° C. and pH was adjusted to be about 9.0 by controlling the amount of liquid ammonia. Potassium persulfate (1.5 g) was put into this solution, the temperature of the solution was adjusted to 80° C., and the mixed solution of styrene (20 g) and 2-ethyl hexyl acrylate (20 g) was added slowly to the mixture for 2 hours while stirring the mixture. After the addition of the monomer mixture in drops was completed, the reaction was completed by stirring the mixture at the same temperature for 1 more hour in order to obtain an emulsion, in which core-shell-structured corpuscles having the diameter of about 70 nm were dispersed.

### MANUFACTURING EXAMPLE 2

### Manufacture of Insulation Resin Powder (Core-Shell-Structured Resin) According to the Present Invention

Manufacture of a Shell (SAA Resin)

Ammonium persulfate (1.0 g) was added to the mixture of methacrylic acid (5.0 g), acrylic acid (5.0 g), ethyl acrylate (20.0 g), and acrylonitrile (3.0 g), and the mixture was put into a 100-ml high-pressure reactor having a stirrer attached, and heated to 80° C. while adding a little amount of an anionic surfactant. The reaction mixture was stirred at this temperature for 2 hours, and cooled to a room temperature to obtain the reaction product.

Manufacture of a Core-Shell Resin

PH of the above reaction product was adjusted to be about 9.0 by controlling the amount of liquid ammonia. Ammonium persulfate (1.0 g) was put into this solution, the temperature of the solution was adjusted to 80 C, and the mixed solution of styrene (50 g) and methacrylic acid (20 g) was added slowly to the mixture for 1 hour while adding a little amount of a non-ionic surfactant and stirring the mixture. After the addition of the monomer mixture in drops was completed, the reaction was completed by stirring the mixture at the same temperature for 1 more hour in order to obtain an emulsion, in which core-shell-structured corpuscles having the diameter of about 50 nm were dispersed, by using a surfactant.

### MANUFACTURING EXAMPLE 3

### Manufacture of Resin Powder Having the Water-Emission Ability According to the Present Invention

Perfluorinated alkyl acrylate (TA-N of Du Pont Company, 10.0 g), stearyl acrylate (9.0 g), glycidyl methacrylate (1.0 g), methoxyacrylamide (1.0 g), and 3-chloro-2-hydroxypropyl methacrylate (0.2 g) were put into a 200-ml round-bottom flask along with acetone (10 g), and mixed. After 0.1 g of azoisobutyronitrile (AIBN) was added to this mixture, NP-10 (10 g) as a non-ionic surfactant and trimethylsteary-lammonium chloride (1 g) as a cationic surfactant were put into the mixture to make an emulsion when the temperature of the mixture reached 50° C. An emulsion solution, in which corpuscles having the diameter of about 70 nm were dispersed, was obtained by heating the mixture to 60° C. and stirring for 8 hours.

### MANUFACTURING EXAMPLE 4

### Manufacture of Insulation Resin Powder

Styrene (10 g) and 2-ethyl hexyl acrylate (10 g) were put into a 100-□ round-bottom flask along with toluene (50 g), and mixed. 0.2 g of azoisobutyronitrile (AIBN) was added to the mixture, and the mixture was heated to 70° C. and stirred for 24 hours. The reaction product was obtained in the form of precipitates by putting it in methanol in drops, and resin powder was obtained by drying the precipitates in a vacuum oven under a reduced pressure.

### PREFERRED EMBODIMENTS 1˜5

Anionic conductive balls for electric connection coated with insulation resin layers comprised of an insulation resin as well as resin layers having the water-emission ability were obtained by coating the conductive balls, in which the surfaces of di-vinylbenzene acryl co-polymer particles having the diameter of 5□ were plated with Ni and Au, with the aqueous insulation resin solution obtained in the above Manufacturing Examples 1 and 2, and then, an aqueous resin solution having the water-emission ability obtained in the above Manufacturing Example 3. The process of coating was as follows:

An emulsion solution of which 20% was the solid part was obtained by diluting the insulation resin emulsion manufactured in the above with water. 1 g of conductive balls was put into this emulsion solution, and stirred slowly at 60° C. for 1 hour. After the conductive balls were sunken by having the mixture stood still at a room temperature for 20 minutes, the emulsion layer was poured out, and the conductive balls at the bottom were washed once with the mixture of water and ethanol and once with ethanol in order to wash out resin corpuscles that were not attached to the surfaces of the conductive balls.

Next, an emulsion solution having 30% solid part was obtained by diluting the resin emulsion having the water-emission ability with water. This emulsion was pout into the reaction products coated with the above insulation resin layers and stirred slowly at 60° C. for 1 hour. The process of washing was the same as that of the insulation layer resin. The conductive balls coated with the insulation layer and the resin having the water-emission ability were dried at a temperature of 40° C. while stirring occasionally in order to prevent entanglement. It was confirmed that thus obtained insulated conductive balls had 220-nm-thick insulation resin layers as a result of TGA analysis.

The composition of each component for obtaining anisotropic conductive balls for electric connection coated in similar methods, the ratio of coating (%) of the insulation resin layer of each conductive ball obtained, and the average thickness (nm) of the insulation resin layers are shown in the following Table 1:

TABLE 1
Compositions and characteristics of preferred embodiments of the present invention

| | | | Types of | | | | |
|---|---|---|---|---|---|---|---|
| | | Insulation | insulation | | | | |
| Preferred | | core-shell | core-shell | water-emission | Conductive | Ratio of | Thickness |
| Embodiment | Water (g) | resin (g) | resins | resin | balls (g) | coating (%) | (nm) |
| 1 | 100 | 1 | Manufacturing | 20 | 1 | 74 | 80 |
| | | | Example 1 | | | | |
| 2 | 100 | 10 | Manufacturing | 20 | 2 | 88 | 149 |
| | | | Example 1 | | | | |
| 3 | 100 | 20 | Manufacturing | 30 | 1 | 94 | 220 |
| | | | Example 1 | | | | |
| 4 | 100 | 50 | Manufacturing | 20 | 2 | 98 | 245 |
| | | | Example 1 | | | | |
| 5 | 100 | 50 | Manufacturing | 50 | 2 | 100 | 312 |
| | | | Example 2 | | | | |

### COMPARATIVE EXAMPLES 1˜9

Anisotropic conductive balls for electric connection coated with insulation resin layers formed with an insulation resin were obtained by coating conductive balls, made by plating the surfaces of divinylbenzene acryl co-polymer corpuscles having a diameter of 5□ with Ni and Au, with insulation resin powder (co-polymer of styrene and 2-ethyl hexyl acrylate) melted in toluene.

1 g of conduction balls was put into the solution, in which 10 g of the co-polymer of styrene and 2-ethyl hexyl acrylate obtained in Manufacturing Example 2 was melted in 100 g of toluene, and the solution was stirred slowly at 40° C. for 1 hour. After stirring was completed, the conductive balls were filtered, separated, washed twice with ethanol, and dried in a vacuum oven under a reduced pressure. It was confirmed that thus obtained insulation conductive balls were coated with 10-nm-thick resin layers as a result of TGA analysis.

The composition of each component for obtaining anisotropic conductive balls for electric connection coated in similar methods, the ratio of coating (%) of the insulation resin layer of each conductive ball obtained, and the average thickness (nm) of the insulation resin layers are shown in the following Table 2:

TABLE 2
Compositions and characteristics of comparative examples

| | | | | Ratio of | Average |
|---|---|---|---|---|---|
| Comparative | Toluene | Insulation | Conductive | coating | thickness of |
| Exampli | (g) | resin (g) | balls (g) | (%) | films (nm) |
| 1 | 100 | 1 | 5 | 80 | NA |
| 2 | 100 | 10 | 1 | 96 | 10 |
| 3 | 100 | 20 | 1 | 99 | 18 |
| 4 | 100 | 50 | 1 | 100 | 26 |
| 5 | 100 | 10 | 2 | 90 | 14 |
| 6 | 100 | 20 | 2 | 95 | 19 |
| 7 | 100 | 50 | 2 | 98 | 21 |
| 8 | 100 | 10 | 3 | 83 | 14 |
| 9 | 100 | 50 | 3 | 95 | 23 |

Any of the anisotropic conductive balls for electric connection obtained in the above preferred embodiments and comparative examples was added to the mixture of 12 parts by weight of bisphenol-A solid epoxy resin (YDF-101 manufactured by Kookdo Chemical Company), 48 parts by weight of bisphenol-A liquid epoxy resin (YDF-128 manufactured by Kookdo Chemical Company), 40 parts by weight of a lysogenic hardening agent (H-3042 manufactured by Kookdo Chemical Company), and 60 parts by weight of methyl ethyl ketone at a ratio of 25 weight %, and mixed homogeneously. Anisotropic films for electric connection were manufactured by coating polyimide films treated with silicon with this mixture to have a thickness of 25□ when dried, and drying.

Then, connection structural bodies were obtained by inserting thus manufactured anisotropic film for electric connection into the gap between glass substrates equipped with a 50- [symbol] -pitch (bump size of 35 80 [symbol] , bump interval of 15 [symbol] , bump height of 20 [symbol] ) and a 50- [symbol] -pitch ITO (wiring width of 35 [symbol] , wiring interval of 15 [symbol] ), and crimping at a temperature of 190° C. with a pressure of 3 kgf/cm² for 10 seconds. Alive and insulation characteristics of connection structural bodies thus obtained were determined as illustrated below, and the results obtained were shown in the following table 3:

<Alive characteristics>

Rank: Criteria for judgement

◯: When the initial resistance value of all of 100 pins connected were below 5 Ω

Δ: When the initial maximun resistance value of 100 pins connected exceeded 5 Ω but less than 10 Ω

×: When the initial maximum resistance value of 100 pins connected exceeded 10 Ω

<Insulation characteristics>

Rank: Criteria for judgement

◯: Whne the resistance value of 100 pins in the non-connected state was greater than 10⁸ Ω

Δ: When the minimum resistance value of 100 pins in the non-connected state was greater than 10⁶ Ω

×: When the minimum resistance value of 100 pins in the non-connected state was greater than 10⁶ Ω

TABLE 3
Characteristics of conductive balls according to preferred embodiments
and comparative examples

| Preferred | Alive | Insulation | Comparative | Alive | Insulation |
|---|---|---|---|---|---|
| Embodiment | Characteristics | Characteristics | Example | Characteristics | Characteristics |
| 1 | ◯ | ◯ | 1 | ◯ | X |
| 2 | ◯ | ◯ | 2 | ◯ | X |
| 3 | ◯ | ◯ | 3 | ◯ | X |
| 4 | Δ | ◯ | 4 | ◯ | X |
| 5 | Δ | ◯ | 5 | ◯ | X |
| | | | 6 | ◯ | X |
| | | | 7 | ◯ | X |
| | | | 8 | ◯ | X |
| | | | 9 | ◯ | X |

It was seen from the results of Tables 1˜3, particularly, the results of Preferred Embodiments 1˜5, that conductive balls having improved functions of insulation resin layers as insulation layers were formed through coating with a core-shell-structured water-soluble resin, or emulsion- or suspension-phase resin, and their shells were coated with resin layers having the water-emission ability had superior alive and insulation characteristics compared to those of conductive balls coated with general resins. Further, it was confirmed from the results of Preferred Embodiment 1 and Comparative Examples 1˜9 that insulation characteristics were superior if the thickness of the insulation layers was greater than 10 nm, more preferably, greater than 50 nm.

Still further, it was confirmed that insulation resin layers were not damaged by putting the insulated conductive balls manufactured for testing of solvent resistance of insulation films into the MEK solvent, stirring for 3 hours, and observing their surfaces.

### INDUSTRIAL APPLICABILITY

As illustrated in the above, the anisotropic conductive balls for electric connection according to the present invention shows superior alive or insulation characteristics as their surfaces are coated with an insulation resin and a resin having the water-emission ability, and the problems with the conventional anisotropic conductive balls for electric connection coated with a thermoplastic resin or a thermosetting resin are improved. They are also advantageous in that they can solve the problem of reliability brought about when they are exposed to the conditions of high temperature and high humidity.

While certain present manufacturing examples and preferred embodiments of the invention have been shown and described, it is to be distinctly understood that the invention is not limited thereto but may be otherwise variously embodied and practiced within the scope of the following claims.

1. An anisotropic conductive ball for electric connection comprising a conductive ball and an insulation resin layer coating the surface of said conductive ball, wherein said conductive ball is coated with a core-shell-structured emulsion, suspension, or water-dispersible resin, and the shell of said conductive ball is formed with an insulation resin layer coated with a resin having the water-emission ability.

2. The anisotropic conductive ball for electric connection in claim 1, wherein said core is formed with the co-polymer of styrene and alkyl methacrylate having a molecular weight of 100,000˜1,000,000, and said shell is formed with a resin containing styrene and methacrylic acid.

3. The anisotropic conductive ball for electric connection in claim 1, wherein said resin having the water-emission ability is the co-polymer of perfluoromethacrylate and an alkyl acrylate having an average molecular weight of 50,000-500,000 or silicon acryl co-polymer having an average molecular weight of 20,000-300,000.

4. The anisotropic conductive ball for electric connection in claim 1, wherein the diameter of said water-soluble resin in the emulsion or suspension phase having said core-shell structure is 10˜200 nm.

5. The anisotropic conductive ball for electric connection in claim 1, wherein the glass transition temperature of said water-soluble resin in the emulsion or suspension phase is −30˜180° C.

6. The anisotropic conductive ball for electric connection in claim 1, wherein the thickness of said insulation resin layer is ⅕ or less of the diameter of said conductive ball but 10 nm or greater.

7. The anisotropic conductive ball for electric connection in claim 1, wherein said conductive ball is a conductive ball made by plating the surface of a metal corpuscle or resin corpuscle with a metal.

8. A method of manufacture of an anisotropic conductive ball for electric connection in comprising the steps of:
manufacturing a resin forming a shell layer containing styrene and methacrylic acid;
manufacturing an emulsion solution in which core-shell-structured corpuscles are dispersed by polymerizing a monomer of which main components are styrene and alkyl methacrylate after dissolving said resin in water;
manufacturing a conductive ball coated with an insulation resin layer by inputting said conductive ball into said emulsion solution and stirring; and
coating said conductive ball with a resin having the water-emission ability.

9. The method of manufacture of an anisotropic conductive ball for electric connection in claim 8, wherein said resin having the water-emission ability is the co-polymer of a perfluorinated alkyl acrylate and an alkyl acrylate or the co-polymer of silicon and acrylic acid.

10. The method of manufacture of an anisotropic conductive ball for electric connection in claim 9, wherein an average molecular weight of said co-polymer of a perfluoriiniated alkyl acrylate and an alkyl acrulate is 50,000-500,000, and an average molecular weight of said copolymer of silicon and acrylic acid is 20,000-300,000.

11. The method of manufacture of an anisotropic conductive ball for electric connection in claim 8, wherein the diameter of said water-soluble resin in the emulsion or suspension phase having said core-shell structure is 10˜200 nm.

12. The method of manufacture of an anisotropic conductive ball for electric connection in claim 8, wherein the glass transition temperature of said water-soluble resin in the emulsion or suspension phase is −30˜180° C.

13. The method of manufacture of an anisotropic conductive ball for electric connection in claim 8, wherein the thickness of said insulation resin layer is ⅕ or less of the diameter of said conductive ball but 10 nm or greater.

14. The method of manufacture of an anisotropic conductive ball for electric connection in claim 8, wherein said conductive ball is a conductive ball made by plating the surface of a metal corpuscle or resin corpuscle with a metal.

15. An anisotropic material for electric connection formed as a multiple number of said anisotropic conductive balls for electric connection in Claim 1 is dispersed in an insulating adhesive.

16. Connection structural bodies wherein two objects to be connected facing each other are connected by the anisotropic material for electric connection in claim 15.
